(19) United States
(12) Patent Application Publication
(10) Pub. No.: US 2011/0085086 A1
(43) Pub. Date: Apr. 14, 2011

(54) METHOD FOR ADAPTIVE NOISE REDUCTION AND APPARATUS THEREOF

(76) Inventors: Miaohong Shi, Grand Cayman (KY); Amit Mittra, Grand Cayman (KY)

(21) Appl. No.: 12/577,214

(22) Filed: Oct. 12, 2009

(51) Int. Cl. H04N 5/217

(52) U.S. Cl. 348/624; 348/E05.078

(57) ABSTRACT

An adaptive noise reduction method is for reducing chroma noise of pixels within a frame, wherein each pixel has a chroma value and a luma value. The adaptive noise reduction method includes: de-noising the chroma values of the pixels, without de-noising the luma values of the pixels.

### BACKGROUND OF THE INVENTION

1. Field of the Invention

The present invention relates to a method and an apparatus of noise reduction, and more particularly, to a method and related apparatus of adaptive noise reduction without de-noising the luma values of the pixels.

2. Description of the Prior Art

As display techniques progress, the corresponding pixel sizes become smaller and smaller. This decrease in pixel size, however, results in an increase of noise. Noise exists not only in the luma channel but also in the chroma channel. Noise in the chroma channel is more visible, more unnatural to human vision, and therefore more disturbing than noise in the luma channel, although signals in the luma channel keep the output image sharp. Therefore, a method for reducing chroma noise and keeping image edges sharp at the same time is a crucial topic in the image processing field.

### SUMMARY OF THE INVENTION

The present invention provides an adaptive method and an apparatus thereof for reducing chroma noise while preserving image sharpness.

In accordance with a first aspect of the present invention, an adaptive noise reduction method is disclosed. The adaptive noise reduction method is for reducing chroma noise of pixels within a frame, wherein each pixel has a chroma value and a luma value. The adaptive noise reduction method includes: de-noising the chroma values of the pixels, without de-noising the luma values of the pixels.

In accordance with another embodiment of present invention, an adaptive noise reducing apparatus is provided for pixels of a frame, wherein each pixel has a chroma value and a luma value. The noise reducing apparatus includes: a processing circuit and a noise reducing circuit. The processing circuit determines a chroma noise reduction coefficient according to a global gain; and the noise reducing circuit multiplies chroma values of the pixels within the frame by the chroma noise reduction coefficient.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an adaptive noise reducing apparatus according to a first embodiment of the present invention.

FIG. 2 is an exemplary chart showing the chroma noise reduction coefficient v.s. the global gain.

FIG. 3 is a block diagram of an adaptive noise reducing apparatus according to a second embodiment of the present invention.

FIG. 4 is an exemplary chart of the chroma noise reduction coefficient v.s. the luma value of a designated pixel.

FIG. 5 is a block diagram of an adaptive noise reducing apparatus according to a third embodiment of the present invention.

FIG. 6 is a diagram of a designated pixel and its nearby pixels.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

One objective of the present invention is to reduce chroma noise without degrading image sharpness. In order to achieve this goal, various chroma suppression methods at different levels (pixel level, frame level, etc.) as well as a chroma data blurring method are disclosed in the following paragraphs.

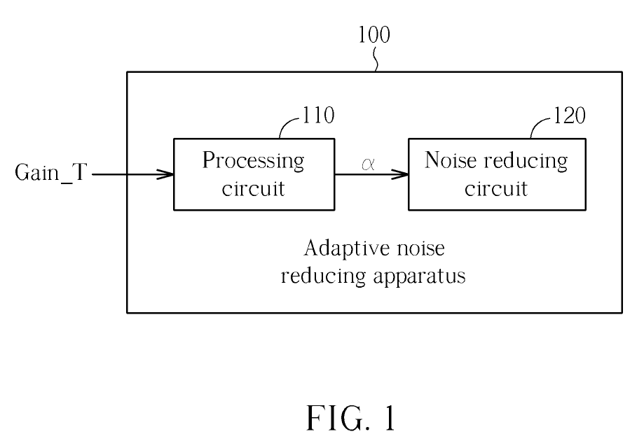

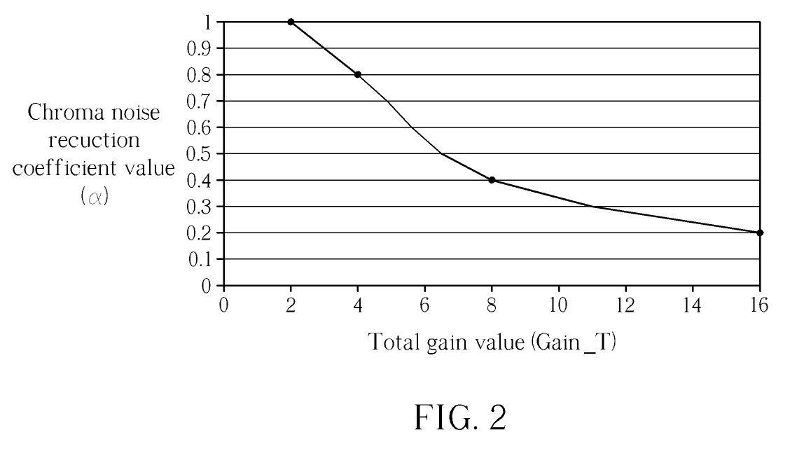

FIG. 1 is a block diagram of an adaptive noise reducing apparatus 100 according to a first embodiment of the present invention. The exemplary adaptive noise reducing apparatus 100 includes a processing circuit 110 and a noise reducing circuit 120. In this embodiment, a frame, which includes a plurality of pixels each having a plurality of chroma values and a plurality of luma values in a color space (e.g., a YUV color space or a Lab color space, etc.), is adjusted by a global gain in response to a light intensity thereof. When the light intensity of the frame gets darker, the corresponding global gain is increased to enhance the luminance; when the light intensity of the frame gets brighter, the corresponding global gain is decreased to reduce the luminance. However, when the light intensity of the frame is increased by the adjustment of the global gain, a noise level is also inevitably increased. Therefore, this embodiment employs the processing circuit 110 to read the global gain Gain_T of the frame and determine a chroma noise reduction coefficient α inversely proportional to the global gain Gain_T. The noise reducing circuit 120 then multiplies chroma values of the pixels within the frame by the determined chroma noise reduction coefficient α. For example, the chroma noise reduction coefficient α can be determined by a table or a piecewise linear curve according to the global gain Gain_T. Please refer to FIG. 2, which is an exemplary chart showing the chroma noise reduction coefficient α v.s. the global gain Gain_T. Assuming a pixel within the frame has a chroma value, including U and V in a YUV color space (or a chroma value, including a, b in a Lab color space), the processed pixel will have a noise-suppressed chroma value, such as U′=U*α and V′=V*α in the YUV color space (or a′=α and b′*b*α in the Lab space). In this way, the chroma noise of the frame can be reduced without affecting signals in the luma channel. The image sharpness of the frame is therefore maintained.

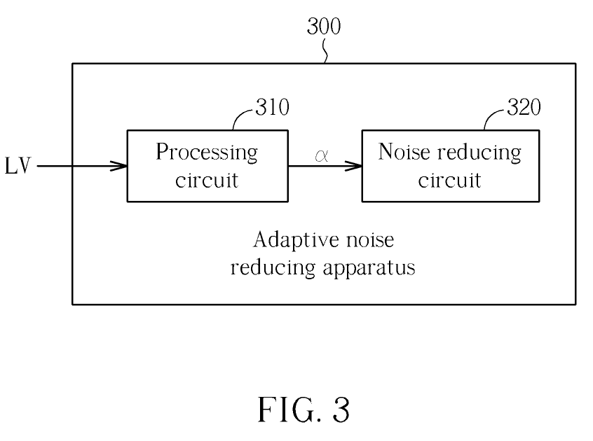

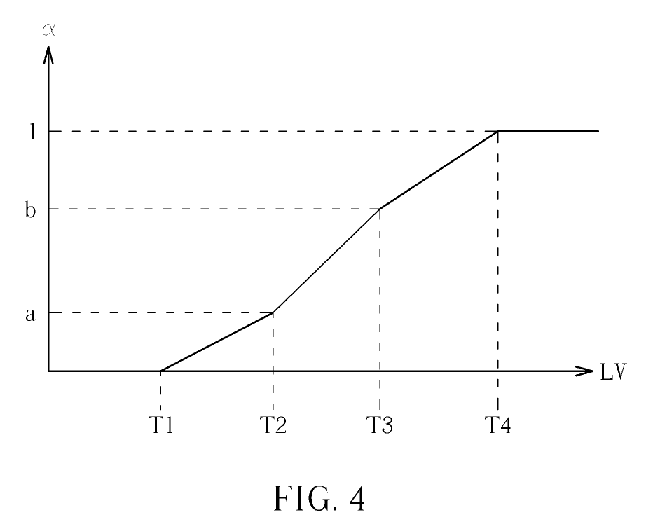

A second embodiment of the present invention provides a chroma noise reduction apparatus and a method thereof at the pixel level. Please refer to FIG. 3. FIG. 3 is a block diagram of an adaptive noise reducing apparatus 300 according to a second embodiment of the present invention. The exemplary adaptive noise reducing apparatus 300 includes a processing circuit 310 and a noise reducing circuit 320. Assume that a designated pixel has at least one chroma value and at least one luma value in a color space (e.g., a YUV color space or a Lab color space, etc.). Since chroma noise is more obvious in darker areas, more chroma noise suppression should be applied in the darker areas while less chroma noise suppression is needed in the brighter areas. Therefore, in this embodiment, the processing circuit 310 is utilized to read the luma value LV of the designated pixel and determine a chroma noise reduction coefficient α in proportion to the luma value LV thereof, and the noise reducing circuit 320 then multiplies the chroma value of the designated pixel with the chroma noise reduction coefficient α. For example, in a YUV color space, the designated pixel has chroma values U, V and a luma value Y. The chroma values U, V are adaptively reduced according to the luma value Y when the luma value Y is decreased. The chroma noise reduction coefficient α can be determined by a table or a piecewise linear curve according to the luma value LV. Please refer to FIG. 4, which is an exemplary chart of the chroma noise reduction coefficient α v.s. the luma value LV of the designated pixel. The relation between the chroma noise reduction coefficient α and the luma value LV is a piecewise linear curve with four thresholds T1-T4 in FIG. 4. The chroma noise reduction coefficient α is therefore determined according to the following equation.

$$α = \{ \begin{matrix}0 & When Y < T 1 \\ ( ( Y - T 1 ) / ( T 2 - T 1 ) ) * a & When T 1 \leq Y < T 2 \\ ( ( Y - T 2 ) / ( T 3 - T 2 ) ) * ( b - a ) + a & When T 2 \leq Y < T 3 \\ ( ( Y - T 3 ) / ( T 4 - T 3 ) ) * ( 1 - b ) + b & When T 3 \leq Y < T 4 \\ 1 & When T 4 \leq Y\end{matrix} \} \qquad ( 1 )$$

As shown in FIG. 4, for pixels in the brightest area, i.e., the pixels having a luma value larger than or equal to the threshold T4, the chroma noise-suppressed pixel has the same chroma values since the chroma noise reduction coefficient α=1, whereas for the pixels in the darkest area, i.e., the pixels having a luma value less than or equal to the threshold T1, the chroma noise-suppressed pixel has zero chroma value since the chroma noise reduction coefficient α=0. In this way, the chroma noise of the designated pixel can be adaptively reduced according to the luma value, and the image sharpness is maintained. And finally, the processing circuit 310 repeats determining the noise reduction coefficient of each pixel of the frame and the noise reducing circuit 320 repeats multiplying the chroma value of each pixel of the frame by each corresponding chroma noise reduction coefficient for each pixel of the frame, respectively.

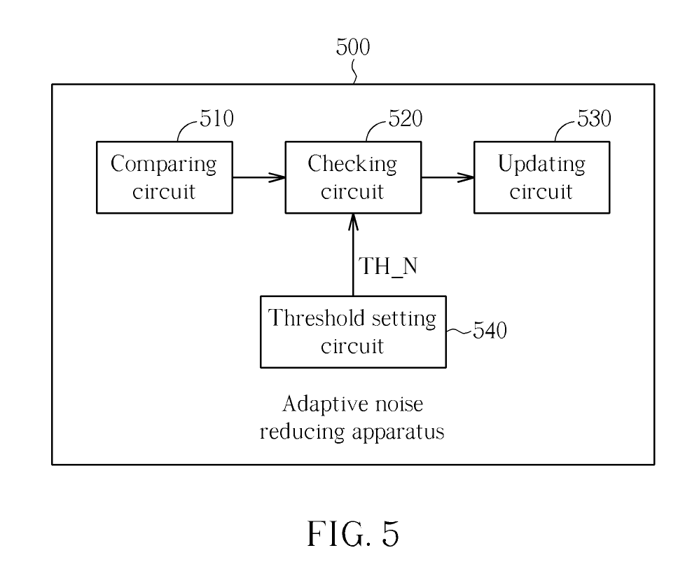

In a third embodiment of the present invention, a method and an apparatus for reducing chroma noise by blurring chroma data are disclosed. Please refer to FIG. 5, which is a block diagram of an adaptive noise reducing apparatus 500 according to a third embodiment of the present invention. The adaptive noise reducing apparatus 500 includes a comparing circuit 510, a checking circuit 520, an updating circuit 530, and a threshold setting circuit 540. In this embodiment, the chroma noise reducing apparatus 500 reduces chroma noise of a designated pixel within a frame, wherein each pixel within the frame has a chroma value and a luma value in a color space (e.g., a YUV color space or a Lab color space). The comparing circuit 510 compares the chroma value of the designated pixel with chroma values of a plurality of nearby pixels within the frame. In this embodiment, the nearby pixels are pixels that are only one pixel away from the designated pixel. However, this is for illustrative purposes only, and is not meant to be a limitation of the present invention. In an alternative design, the nearby pixels can also be pixels that are at a distance of more than one pixel from the designated pixel. This kind of design variation still falls within the scope of the present invention. The checking circuit 520 checks each nearby pixel of the nearby pixels by checking whether a difference between the chroma value of the designated pixel and a chroma value of the nearby pixel is smaller than a noise threshold TH_N, wherein the noise threshold TH_N is adaptively adjusted according to a global gain applied in response to a light intensity by the threshold setting circuit 540; additionally, when the difference between the chroma value of the designated pixel and the chroma value of the nearby pixel is smaller than the noise threshold TH_N, the checking circuit 520 sets the nearby pixel as a similar nearby pixel. Next, the updating circuit 530 updates the chroma value of the designated pixel according to the chroma value of the designated pixel and a chroma value of each similar nearby pixel identified by the checking circuit 520.

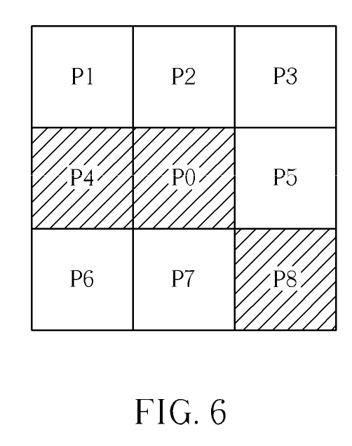

Please refer to FIG. 6, which is a diagram of a designated pixel P0 and its nearby pixels P1-P8. Assume only the pixels P4 and P8 have chroma values differing from the chroma value of the designated pixel P0 by difference values smaller than the noise threshold TH_N, i.e., the pixels P4 and P8 are categorized as similar nearby pixels. In this example, the updating circuit 530 averages the chroma value CV₀ of the designated pixel P0 and the chroma values CV₄, CV₈ of the similar nearby pixels P4 and P8 to derive a blurred chroma value CV′ (i.e.,

$${CV}^{′} = \frac{1}{3} ( {CV}_{0} + {CV}_{4} + {CV}_{8} ) ) ,$$

and then updates the chroma value CV₀ of the designated pixel P0 by this blurred chroma value CV′. In this way, the chroma noise of the designated pixel P0 can be effectively suppressed without degrading the image sharpness.

To summarize, the present invention provides methods and apparatuses for reducing noise at frame level and pixel level. With the aforementioned methods and apparatuses, the chroma noise within an image can be effectively suppressed without affecting the image sharpness.

Those skilled in the art will readily observe that numerous modifications and alterations of the device and method may be made while retaining the teachings of the invention.

What is claimed is:

1. A noise reduction method for pixels of a frame, each pixel having a chroma value and a luma value, the method comprising:
de-noising the chroma values of the pixels, without de-noising the luma values of the pixels.

2. The noise reduction method of claim 1, wherein the chroma values and the luma values are generated by applying a global gain;
wherein the chroma de-noising step comprises:
determining a chroma noise reduction coefficient according to the global gain; and
multiplying the chroma values of the pixels by the chroma noise reduction coefficient.

3. The noise reduction method of claim 2, wherein the chroma noise reduction coefficient is inversely proportional to the global gain.

4. The noise reduction method of claim 2, wherein when the global gain is equal to a first gain, the chroma noise reduction coefficient is set by a first coefficient; and when the global gain is equal to a second gain larger than the first gain, the chroma noise reduction coefficient is set by a second coefficient smaller than the first coefficient.

5. The noise reduction method of claim 1, wherein the chroma de-noising step comprising:
determining a chroma noise reduction coefficient according to the luma value of one designated pixel of the pixels; and
multiplying the chroma value of the designated pixel by the chroma noise reduction coefficient.

6. The noise reduction method of claim 5, wherein the chroma noise reduction coefficient is determined in proportion to the luma value of the designated pixel.

7. The noise reduction method of claim 5, wherein the chroma de-noising step further comprises:
setting at least a threshold;
when the luma value is smaller than the threshold, assigning a first value to the chroma noise reduction coefficient; and
when the luma value is not smaller than the threshold, assigning a second value larger than the first value to the chroma noise reduction coefficient.

8. The noise reduction method of claim 5, wherein, the chroma de-noising step, the coefficient determining step and the multiplying step are repeated for each pixel of the frame.

9. The noise reduction method of claim 1, wherein the chroma values and the luma values are generated by applying a global gain;
wherein the chroma de-noising step comprises:
determining a noise threshold according to the global gain;
comparing the chroma value of one target pixel of the frame with the chroma values of nearby pixels of the frame;
for each nearby pixel of the nearby pixels:
determining if the chroma value of the target pixel is similar to a chroma value of the nearby pixel according to the noise threshold; and
when the chroma value of the target pixel is determined similar to the chroma value of the nearby pixel, setting the nearby pixel as a similar nearby pixel; and
updating the chroma value of the target pixel according to the chroma value of the target pixel and the chroma value of each similar nearby pixel.

10. The noise reduction method of claim 9, wherein the global gain is determined in response to a light intensity.

11. A noise reduction apparatus for pixels of a frame, each pixel having a chroma value and a luma value, the apparatus comprising:
a processing circuit, for determining a chroma noise reduction coefficient; and
a noise reducing circuit, coupled to the processing circuit, for multiplying the chroma values of the pixels by the chroma noise reduction coefficient.

12. The noise reduction apparatus of claim 11, wherein the chroma values and the luma values are generated by applying a global gain, and the chroma noise reduction coefficient is determined based on the global gain.

13. The noise reduction apparatus of claim 12, wherein the chroma noise reduction coefficient is inversely proportional to the global gain.

14. The noise reduction method of claim 12, wherein when the global gain is equal to a first gain, the processing circuit sets the chroma noise reduction coefficient by a first coefficient; and when the global gain is equal to a second gain larger than the first gain, the processing circuit sets the chroma noise reduction coefficient by a second coefficient smaller than the first coefficient.

15. The noise reduction apparatus of claim 11, wherein the noise reduction apparatus comprises:
a processing circuit, for determining a chroma noise reduction coefficient according to the luma value of one designated pixel of the pixels; and
a noise reducing circuit, coupled to the processing circuit, for multiplying the chroma value of the designated pixel by the chroma noise reduction coefficient.

16. The noise reduction apparatus of claim 15, wherein the chroma noise reduction coefficient is determined in proportion to the luma value of the designated pixel.

17. The noise reduction apparatus of claim 15, wherein the processing circuit further sets at least a threshold; when the luma value is smaller than the threshold, assigning a first value to the chroma noise reduction coefficient; and when the luma value is not smaller than the threshold, assigning a second value larger than the first value to the chroma noise reduction coefficient.

18. The noise reduction apparatus of claim 15, wherein the processing circuit repeats determining the noise reduction coefficient of each pixel of the frame and the noise reducing circuit repeats multiplying the chroma value of each pixel of the frame by each corresponding chroma noise reduction coefficient for each pixel of the frame, respectively.

19. The noise reduction apparatus of claim 11, wherein the chroma values and the luma values are generated by applying a global gain;
wherein the noise reduction apparatus comprises:
a threshold setting circuit, for determining a noise threshold according to the global gain;
a comparing circuit, for comparing the chroma value of one target pixel of the frame with the chroma values of nearby pixels of the frame;
a checking circuit, coupled to the comparing circuit and the threshold setting circuit, for checking each nearby pixel of the nearby pixels by:
checking whether a difference between the chroma value of the designated pixel and a chroma value of the nearby pixel is smaller than the noise threshold; and
when the difference between the chroma value of the designated pixel and the chroma value of the nearby pixel is smaller than the noise threshold, setting the nearby pixel as a similar nearby pixel; and
an updating circuit, coupled to the checking circuit, for updating the chroma value of the designated pixel according to the chroma value of the designated pixel and a chroma value of each similar nearby pixel.

20. The noise reduction apparatus of claim 19, wherein the global gain is determined in response to a light intensity.
